(19) United States
(12) Patent Application Publication
(10) Pub. No.: US 2025/0171300 A1
(43) Pub. Date: May 29, 2025

(54) LOW TEMPERATURE NH3-REFORMING UNDER ELEVATED PRESSURE

(71) Applicant: BASF SE, Ludwigshafen am Rhein (DE)

(72) Inventors: Elias Christopher FREI, Ludwigshafen am Rhein (DE); Virginie LANVER, Ludwigshafen am Rhein (DE); Adelheid SCHULZ, Ludwigshafen am Rhein (DE); Chiara BOSCAGLI, Hamburg (DE); Thomas HEIDEMANN, Ludwigshafen am Rhein (DE); Nils BOTTKE, Ludwigshafen am Rhein (DE); Jan Philipp HERRMANN, Ludwigshafen am Rhein (DE)

(21) Appl. No.: 18/843,325

(22) PCT Filed: Mar. 3, 2023
(86) PCT No.: PCT/EP2023/055445

§ 371 Date: Sep. 3, 2024

(30) Foreign Application Priority Data
Mar. 4, 2022 (EP) 22160163.6

(51) Int. Cl. C01B 3/04; B01J 21/06; B01J 23/00; B01J 23/02; B01J 23/58; B01J 23/89; B01J 35/61; B01J 35/63; B01J 37/02; B01J 37/08; B01J 37/18; C01B 3/40

(52) U.S. Cl. CPC C01B 3/047; B01J 21/066; B01J 23/005; B01J 23/02; B01J 23/58; B01J 23/8946; B01J 35/613; B01J 35/633; B01J 35/635; B01J 35/638; B01J 37/0205; B01J 37/0236; B01J 37/08; B01J 37/18; C01B 3/40; C01B 2203/0233; C01B 2203/0277; C01B 2203/1064; C01B 2203/1082; C01B 2203/1235

(57) ABSTRACT

The present invention relates to a process for the reforming of ammonia, wherein the process comprises
(i) providing a reactor containing a catalyst comprising Ru supported on one or more support materials, wherein the one or more support materials display a BET surface area of 20 m²/g or more, and wherein the catalyst contains 1 wt.-% or less of Ni and Co;
(ii) preparing a feed gas stream comprising NH₃;
(iii) feeding the feed gas stream prepared in (ii) into the reactor and contacting the feed gas stream with the catalyst at a pressure of greater than 10 bara and at a temperature in the range of from 200 to 750° C.;
(iv) removing an effluent gas stream comprising H₂ and N₂ from the reactor.

### TECHNICAL FIELD

The present invention relates to a process for the reforming of ammonia, and more specifically to a process for the reforming of ammonia employing a Ru-containing catalyst at low temperatures and elevated pressure.

### INTRODUCTION

NH₃ is seen as an energy vector of the future, able to store chemically significant amounts of H₂. So, sustainable NH₃ might be produced on a large scale from regenerative energy sources. The reforming of NH₃ (see equation 1 below) on site, where the H₂ is needed, might be the last step in closing an H₂ value chain based on renewable electricity.

2NH₃=N₂+3H₂ (1)

For enhancing the decomposition of ammonia to nitrogen and hydrogen, the use of supported Ru catalysts have been discussed. Thus, by way of example, K. Lamb et. al. in Int. J. of Hydrogen Energy 2019, 44, 3726-3736 studies the kinetics of ammonia decomposition over LiOH-promoted Ru/Al₂O₃. A. Di Carlo et al. in Int. J. of Hydrogen Energy 2014, 39, 808-814, on the other hand, studies ammonia decomposition over a commercial Ru/Al₂O₃ catalyst at different operative pressures and temperatures, wherein it is noted that greater dissociation rates are achieved at lower pressures.

T. A. Le et al. in Korean J. Chem. Eng. 2021, 38 (6), 1087-1103 discusses developments of ruthenium and nickel catalysts for COₓ-free H₂ generation by ammonia decomposition. Said document however indicates that alkaline earth metal oxide supports and in particular basic supports such as MgO or neutral supports such as carbon nanotubes would provide better results than amphoteric supports such as Cr₂O₃ and TiO₂ or acidic supports such a Al₂O₃, ZrO₂, or SiO₂.

M. Miyamoto et al. in Int. J. of Hydrogen Energy 2018, 43, 730-738 relates to the doping of ZrO₂ supports for increasing their basicity using La, and their use in reactions for the production of hydrogen. Similarly, B. Lorenzut et al. in ChemCatChem 2010, 2, 1096-1106, discloses the use of lanthanum-stabilized zirconia, and indicates that basic oxides would be more efficient as supports for Ru catalysts as compared to acidic oxides. Z. Wang et al. in Int. J. of Hydrogen Energy 2019, 44, 7300-7307, for its part, relates to a Ba-modified ZrO₂ support for Ru, and its use for ammonia decomposition.

Ru supported on ZrO₂ has also found use as a catalyst in other reactions. Thus, WO 2015/086639 A2 relates to a Ru/ZrO₂ catalyst applied in the hydrogenation of aromatic compounds whereas WO 2018/046393 A1 relates to a Ru/ZrO₂ catalyst applied in the hydrogenation of nitriles.

On the other hand, S.-F. Yin et al. in Applied Catalysis B Environmental 2004, 48, 237-241 relates to the use of carbon nanotubes (CNTs) as a support for Ru nanoparticles in the generation of hydrogen by ammonia decomposition, wherein the order of activities for different supports is indicated to rank as follows: Ru/CNTs>Ru/MgO>Ru/activated carbon>Ru/ZrO₂≅Ru/Al₂O₃.

To have direct access to H₂ at elevated pressure (10-50 bara), the NH₃-reforming itself must however also be conducted at these pressures. Accordingly, there remains a need for an improved and cost-efficient process for NH₃-reforming which allows for the direct provision of H₂ under the conditions required for its further reaction.

In this regard, S. Sayas et al. in Catal. Sci. Technol. 2020, 10, 5027-5035 studies high pressure ammonia decomposition on Ru—K/CaO catalysts at pressures of up to 40 bar. As for T. A. Le et al. in Korean J. Chem. Eng. 2021, 38 (6), 1087-1103, S. Sayas et al. teaches that the nature of the support would have been shown to strongly influence the catalytic performance of Ru-based catalysts, wherein among the use of basic supports like MgO and La₂O₃, neutral supports such as carbon nanotubes, and acidic supports such as Al₂O₃, the use of basic and neutral supports generally results in better catalytic properties.

There, however, remains the need for a highly effective process for the decomposition of ammonia at high pressures. Furthermore, there remains the need for a process for the decomposition of ammonia which is highly active at low temperatures, in particular when used in applications involving high pressure. In addition thereto, there remains the need for a process employing an ammonia decomposition catalyst which displays a high hydrothermal resistance, in particular when used under high pressure conditions, in view of water which may be present during the reaction, in particular in view of the small amounts which are present in industrial grade ammonia for its stabilization.

### DETAILED DESCRIPTION

Thus, a highly efficient process for the high pressure (>10 bar) decomposition of ammonia employing a low temperature (200 to 750° C., preferably 200 to 650° C., more preferably 200 to 600° C.) has surprisingly been found, which may furthermore be employed in the presence of small amounts of water as are present in industrial grade ammonia.

Therefore, the present invention relates to a process for the reforming of ammonia, wherein the process comprises
(i) providing a reactor containing a catalyst comprising Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalyst contains 1 wt.-% or less of Ni and Co calculated as the respective element and based on 100 wt.-% of the catalyst;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of greater than 10 bara, and at a temperature in the range of from 200 to 750° C.;
(iv) removing an effluent gas stream from the reactor, the effluent gas stream comprising H₂ and N₂.

Within the meaning of the present invention, the BET surface area of the one or more support materials refers to the BET surface area of the one or more support materials which is not loaded with any element and/or compound. Furthermore within the meaning of the present invention, in instances wherein the catalyst comprises more than one support material, the BET surface area refers to the BET surface area of each of the one or more support materials, such that each of the more than one support materials displays a BET surface area within the ranges of surface areas as defined in the present invention.

According to the present invention, the catalyst in (i) preferably contains substantially no Ni and Co.

Thus, it is preferred that in (i), the catalyst contains 0.5 wt.-% or less of Ni and Co calculated as the respective element and based on 100 wt.-% of the catalyst, more preferably 0.1 wt.-% or less, more preferably 0.05 wt.-% or less, more preferably 0.01 wt.-% or less, more preferably 0.005 wt.-% or less, and more preferably 0.001 wt.-% or less.

In particular, it is preferred that in (i), the reactor contains 1 wt.-% or less of Ni and Co calculated as the respective element and based on 100 wt.-% of the total contents of the reactor, more preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.

The following two preferred alternatives apply with respect to the BET surface area of the one or more support materials.

According to a first alternative, it is preferred that in (i), the one or more support materials display a BET surface area in the range of from 30 to 800 m²/g, more preferably of from 40 to 500 m²/g, more preferably of from 50 to 300 m²/g, more preferably of from 60 to 200 m²/g, more preferably of from 70 to 100 m²/g, and more preferably of from 75 to 80 m²/g.

According to a second alternative, it is preferred that in (i), the one or more support materials display a BET surface area in the range of from greater than 20 to 150 m²/g, more preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.

It is preferred that in (i), the one or more support materials display a pore volume in the range of from 0.2 to 3 ml/g, more preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.

Within the meaning of the present invention, the pore volume of the one or more support materials refers to the pore volume of the one or more support materials which is not loaded with any element and/or compound. Furthermore within the meaning of the present invention, in instances wherein the catalyst comprises more than one support material, the pore volume refers to the pore volume of each of the one or more support materials, such that each of the more than one support materials displays a pore volume within the ranges of pore volumes as defined in the present invention.

It is preferred that in (i), the catalyst displays a BET surface area in the range of 20 to 800 m²/g, preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.

It is preferred that in (i), the catalyst displays a pore volume in the range of 0.1 to 2 ml/g, more preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.

It is preferred that in (i), from 90 to 100 wt.-% of Ru calculated as the element, and based on 100 wt.-% of Ru contained in the catalyst, is supported on the one or more support materials comprised in the catalyst, more preferably of from 95 to 100 wt.-%, more preferably of from 99 to 100 wt.-%, more preferably of from 99.5 to 100 wt.-%, and more preferably of from 99.9 to 100 wt.-%.

It is preferred that in (i), Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.

It is preferred that in (i), the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.

In the case where in (i), the one or more support materials comprise ZrO₂, it is preferred that the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.

It is preferred that in (i), the one or more support materials contain substantially no CaO and/or MgO, more preferably substantially no CaO and MgO, more preferably substantially no alkaline earth metal oxide, more preferably substantially no Ca and/or Mg, more preferably substantially no Ca and Mg, and more preferably substantially no alkaline earth metal.

It is preferred that in (i), the one or more support materials contain substantially no Al₂O₃ and/or SiO₂, more preferably substantially no Al₂O₃ and SiO₂, more preferably substantially no Al and/or Si, and more preferably substantially no Al and Si

It is preferred that in (i), the one or more support materials contain substantially no carbon nanotubes, more preferably substantially no elemental carbon, and more preferably substantially no carbon.

Within the meaning of the present invention, the term “substantially no” as employed in the present patent application indicates that the element or compound in question is contained in the component in question in an amount of 1 wt.-% or less based on 100 wt.-% of the component in question, preferably of 0.5 wt.-% or less, more preferably of 0.1 wt.-% or less, more preferably of 0.05 wt.-% or less, more preferably of 0.01 wt.-% or less, more preferably of 0.005 wt.-% or less, and more preferably of 0.001 wt.-% or less.

It is preferred that in (i), the catalyst comprises Ru in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

It is preferred that in (i), from 95 to 100 wt.-% of the catalyst consists of Ru and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that in (i), the catalyst further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalyst further comprises KOH and/or LiOH, preferably KOH.

In the case where the catalyst further comprises one or more alkali metal hydroxides, it is preferred that the catalyst comprises the one or more alkali metal hydroxides in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Further in the case where the catalyst further comprises one or more alkali metal hydroxides, it is preferred that from 95 to 100 wt.-% of the catalyst consists of Ru, the one or more alkali metal hydroxides, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that in (i), the catalyst is in the form of a molding and/or in powder form, more preferably in the form of a molding, and more preferably in the form of extrudates or tablets.

In the case where in (i), the catalyst is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

Further in the case where in (i), the catalyst is in the form of extrudates, it is preferred that the extrudates are split, and the catalyst is in the form of extrudates of a split sieve fraction in the range of from 50 μm to 2.5 mm, more preferably of from 100 μm to 1.5 mm, more preferably of from 200 μm to 1 mm, more preferably of from 250 to 700 μm, and more preferably of from 300 to 500 μm.

In the case where in (i) the catalyst is in the form of tablets, it is preferred that the tablets have a four-hole cross-section, more preferably a four-hole cross-section and four flutes.

It is preferred that contacting is performed at a pressure in the range of from 11 to 50 bara, more preferably of from 15 to 45 bara, more preferably of from 15 to 40 bara, more preferably of from 18 to 35 bara, more preferably of from 19 to 31 bara, more preferably of from 20 to 28 bara, and more preferably of from 20 to 25 bara.

It is preferred that contacting is performed at a temperature in the range of from 200 to 650° C., more preferably of from 250 to 600° C., more preferably of from 300 to 550° C., more preferably of from 350 to 520° C., more preferably of from 400 to 500° C., and more preferably of from 430 to 470° C.

It is preferred that the feed gas stream prepared in (ii) comprises from 1 to 100 vol.-% of NH₃, more preferably from 3 to 99.99 vol.-%, more preferably from 5 to 99.95 vol.-%, more preferably from 10 to 99.9 vol.-%, more preferably from 15 to 99.9 vol.-%, more preferably from 20 to 99.8 vol.-%, more preferably from 30 to 99.7 vol.-%, more preferably from 40 to 99.6 vol.-%, and more preferably from 50 to 99.5 vol.-%.

It is preferred that the feed gas stream prepared in (ii) comprises from 0 to 50 vol.-% of N₂, more preferably from 0.01 to 30 vol.-%, more preferably from 0.03 to 15 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.

It is preferred that the feed gas stream prepared in (ii) comprises from 0 to 75 vol.-% of H₂, more preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.

It is preferred that the feed gas stream prepared in (ii) comprises from 100 to 50,000 ppmv of H₂O, more preferably from 200 to 30,000 ppmv, more preferably from 500 to 25,000 ppmv, more preferably from 500 to 20,000 ppmv, more preferably from 500 to 15,000 ppmv, more preferably from 750 to 15,000 ppmv, more preferably from 1,000 to 11,000 ppmv, more preferably from 1,000 to 10,000 ppmv, more preferably from 2,000 to 8,000 ppmv, more preferably from 3,000 to 7,500 ppmv, more preferably from 4,500 to 7,000 ppmv, more preferably from 5,000 to 6,500 ppmv.

It is preferred that the total amount of NH₃, N₂, and H₂ comprised in the feed gas stream prepared in (ii) is in the range from 90 to 100 wt.-%, more preferably from 95 to 99.95 vol.-%, more preferably from 98 to 99.9 vol.-%, more preferably from 99 to 99.85 vol.-%, and more preferably from 99.7 to 99.8 vol.-%.

It is preferred that after (i) and prior to (iii) the catalyst contained in the reactor provided in (i) is reduced in an atmosphere comprising hydrogen.

In the case where after (i) and prior to (iii) the catalyst contained in the reactor provided in (i) is reduced in an atmosphere comprising hydrogen, it is preferred that the reduction is conducted at a temperature in the range of from 20 to 100° C., more preferably of from 24 to 50° C., more preferably of from 26 to 35° C., and more preferably of from 28 to 32° C.

Further in the case where after (i) and prior to (iii) the catalyst contained in the reactor provided in (i) is reduced in an atmosphere comprising hydrogen, it is preferred that the reduction is conducted in an atmosphere comprising from 1 to 50 vol.-% H₂, more preferably from 2 to 20 vol.-%, more preferably from 3 to 10 vol.-%, and more preferably from 4 to 6 vol-%.

Further in the case where after (i) and prior to (iii) the catalyst contained in the reactor provided in (i) is reduced in an atmosphere comprising hydrogen, it is preferred that the atmosphere comprises from 50 to 99 vol.-% of an inert gas, more preferably of from 80 to 98 vol.-%, more preferably of from 90 to 97 vol.-%, and more preferably from 94 to 96 vol.-%. Furthermore, it is preferred that the inert gas comprises one or more gases selected from the group consisting of noble gases, CO₂, and nitrogen, more preferably from the group consisting of He, Ar, Ne, and N₂, CO₂, wherein more preferably the inert gas comprises CO₂, N₂, or CO₂ and N₂, wherein more preferably the inert gas comprises N₂, wherein more preferably the inert gas is N₂.

It is preferred that the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

The following three preferred alternatives apply with respect to the composition of the gas stream prepared in (ii) in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

According to a first alternative, it is preferred that the feed gas stream prepared in (ii) further comprises CO₂ and one or more hydrocarbons, and wherein the feed gas stream more preferably comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O.

According to a second alternative, it is preferred that the feed gas stream prepared in (ii) further comprises H₂O and one or more hydrocarbons, and wherein the feed gas stream preferably comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂.

According to a third alternative, it is preferred that the feed gas stream prepared in (ii) further comprises CO₂, H₂O, and one or more hydrocarbons.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the one or more hydrocarbons are selected from the group consisting of alkanes and mixtures thereof, preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that contacting is performed at a pressure in the range of from greater than 10 to 50 bara, more preferably of from 12 to 45 bara, more preferably of from 15 to 40 bara, more preferably of from 18 to 35 bara, and more preferably of from 20 to 30 bara.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed gas stream prepared in (ii) comprises from 0.1 to 75 vol.-% of NH₃, more preferably from 0.3 to 60 vol.-%, more preferably from 0.5 to 50 vol.-%, more preferably from 0.8 to 40 vol.-%, and more preferably from 1 to 30 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed gas stream prepared in (ii) comprises from 10 to 70 vol.-% of the one or more hydrocarbons, more preferably from 12 to 60 vol.-%, and more preferably from 15 to 50 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed gas stream prepared in (ii) comprises from 0 to 75 vol.-% of H₂O, more preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, and more preferably from 10 to 60 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed gas stream prepared in (ii) comprises from 0 to 60 vol.-% of CO₂, more preferably from 1 to 58 vol.-%, more preferably from 3 to 56 vol.-%, more preferably from 5 to 54 vol.-%, more preferably from 8 to 52 vol.-%, and more preferably from 10 to 50 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed stream displays an H₂O:C molar ratio of H₂O to carbon contained in the one or more hydrocarbons in the range of from 0 to 4, more preferably of from 0.1 to 3, more preferably of from 0.3 to 2.5, more preferably of from 0.4 to 2, and more preferably of from 0.5 to 1.6

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed stream displays a CO₂:C molar ratio of CO₂ to carbon contained in the one or more hydrocarbons in the range of from 0 to 4, more preferably of from 0.1 to 3, more preferably of from 0.2 to 2, and more preferably of from 0.3 to 1.5.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed stream displays an NH₃:C molar ratio of NH₃ to carbon contained in the one or more hydrocarbons in the range of from 0 to 5, more preferably of from 0 to 4, more preferably of from 0.001 to 3, more preferably of from 0.005 to 2, and more preferably of from 0.01 to 1.

It is preferred that the feed stream is fed into the reactor at a gas hourly space velocity in the range of from 500 to 20,000 h⁻¹, more preferably of from 500 to 16,000 h⁻¹, more preferably of from 700 to 14,000 h⁻¹, more preferably of from 800 to 12,000 h⁻¹, more preferably of from 900 to 10,000 h⁻¹, more preferably of from 1,000 to 8,000 h⁻¹, and more preferably of from 3,000 to 5,000 h⁻¹.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) further comprises CO₂.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) displays an H₂:CO molar ratio of >2.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) displays a stoichiometry number R in the range of from 0.1 to 3, wherein R is defined according to formula (I):

$$R = \frac{c ( {H}_{2} ) - c ( {CO}_{2} )}{c ( {CO}_{2} ) + c ( CO )} , \qquad ( I )$$

wherein c(H₂), c(CO₂), and c(CO) stand for the molar concentration of H₂, CO₂, and CO in the effluent gas stream, respectively.

The following three alternatives apply with respect to the stoichiometry number R of the effluent gas stream removed in (iv).

According to a first alternative, it is preferred that the effluent gas stream removed in (iv) displays a stoichiometry number R in the range of from 0.1 to 3, wherein R is defined according to formula (I), it is preferred that the stoichiometry number R is in the range of from 1 to 2.5, more preferably of from 1.3 to 2.2.

According to a second alternative, it is preferred that the effluent gas stream removed in (iv) displays a stoichiometry number R>2. Further, it is preferred according to the second alternative that the effluent gas stream removed in (iv) displays an H₂:CO molar ratio of >2.

According to a third alternative, it is preferred that the stoichiometry number R is in the range of 0.5 to 3, preferably of from 1 to 2.2, and more preferably of 1.3 to 1.7.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) comprises from 10 to 90 vol.-% of H₂, more preferably from 20 to 80 vol.-%, more preferably from 30 to 70 vol.-%, more preferably from 40 to 65 vol.-%, and more preferably from 45 to 60 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) comprises from 1 to 70 vol.-% of CO, more preferably from 3 to 50 vol.-%, more preferably from 5 to 40 vol.-%, more preferably from 10 to 35 vol.-%, and more preferably from 15 to 30 vol.-%.

Further in the case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the effluent gas stream removed in (iv) comprises from 1 to 50 vol.-% of CO₂, more preferably from 3 to 45 vol.-%, more preferably from 5 to 40 vol.-%, more preferably from 8 to 35 vol.-%, more preferably from 10 to 30 vol.-%, and more preferably from 12 to 25 vol.-%.

It is preferred that the effluent gas stream removed in (iv) is employed in a process for the production of methanol, for the production of dimethyl ether, or for the production of methanol and dimethylether.

It is preferred that the effluent gas stream removed in (iv) is employed in a process for the production of hydrocarbons, more preferably according to the Fischer-Tropsch process.

It is preferred that the effluent gas stream removed in (iv) is employed in a process for the production of alcohols, more preferably of alkanols, more preferably of C1 to C10 alkanols, more preferably of C2 to C8 alkanols, more preferably of C2 to C6 alkanols, more preferably of C2 to C4 alkanols, more preferably of C2 alkanols, and more preferably of ethanol.

It is preferred that at an initial stage of the process, the feed gas stream prepared in (ii) and fed into the reactor in (iii) further comprises H₂ for reducing the catalyst.

In the case where at an initial stage of the process, the feed gas stream prepared in (ii) and fed into the reactor in (iii) further comprises H₂ for reducing the catalyst, it is preferred that the feed gas stream prepared in (ii) and fed into the reactor in (iii) further comprises from 0.5 to 80 vol.-% of H₂, more preferably from 1 to 70 vol.-%, more preferably from 2 to 60 vol.-%, more preferably from 5 to 50 vol.-%, more preferably from 15 to 40 vol.-%.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for the reforming of ammonia, wherein the process comprises
   (i) providing a reactor containing a catalyst comprising Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalyst contains 1 wt.-% or less of Ni and Co calculated as the respective element and based on 100 wt.-% of the catalyst;
   (ii) preparing a feed gas stream comprising NH₃;
   (iii) feeding the feed gas stream prepared in (ii) into the reactor provided in (i) and contacting the feed gas stream with the catalyst, wherein contacting is performed at a pressure of greater than 10 bara, and at a temperature in the range of from 200 to 750° C.;
   (iv) removing an effluent gas stream from the reactor, the effluent gas stream comprising H₂ and N₂.
2. The process of embodiment 1, wherein in (i), the catalyst contains 0.5 wt.-% or less of Ni and Co calculated as the respective element and based on 100 wt.-% of the catalyst, preferably 0.1 wt.-% or less, more preferably 0.05 wt.-% or less, more preferably 0.01 wt.-% or less, more preferably 0.005 wt.-% or less, and more preferably 0.001 wt.-% or less.
3. The process of embodiment 1, wherein in (i), the reactor contains 1 wt.-% or less of Ni and Co calculated as the respective element and based on 100 wt.-% of the total contents of the reactor, preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.
4. The process of any of embodiments 1 to 3, wherein in (i), the one or more support materials display a BET surface area in the range of from 30 to 800 m²/g, preferably of from 40 to 500 m²/g, more preferably of from 50 to 300 m²/g, more preferably of from 60 to 200 m²/g, more preferably of from 70 to 100 m²/g, and more preferably of from 75 to 80 m²/g.
5. The process of any of embodiments 1 to 3, wherein in (i), the one or more support materials display a BET surface area in the range of from greater than 20 to 150 m²/g, preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.
6. The process of any of embodiments 1 to 5, wherein in (i), the one or more support materials display a pore volume in the range of from 0.2 to 3 ml/g, preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.
7. The process of any of embodiments 1 to 6, wherein in (i), the catalyst displays a BET surface area in the range of 20 to 800 m²/g, preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.
8. The process of any of embodiments 1 to 7, wherein in (i), the catalyst displays a pore volume in the range of 0.1 to 2 ml/g, preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.
9. The process of any of embodiments 1 to 8, wherein in (i), from 90 to 100 wt.-% of Ru calculated as the element, and based on 100 wt.-% of Ru contained in the catalyst, is supported on the one or more support materials comprised in the catalyst, preferably of from 95 to 100 wt.-%, more preferably of from 99 to 100 wt.-%, more preferably of from 99.5 to 100 wt.-%, and more preferably of from 99.9 to 100 wt.-%.
10. The process of any of embodiments 1 to 9, wherein in (i), Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
11. The process of any of embodiments 1 to 10, wherein in (i), the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.
12. The process of embodiment 11, wherein the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.
13. The process of any of embodiments 1 to 12, wherein in (i), the one or more support materials contain substantially no CaO and/or MgO, preferably substantially no CaO and MgO, more preferably substantially no alkaline earth metal oxide, more preferably substantially no Ca and/or Mg, more preferably substantially no Ca and Mg, and more preferably substantially no alkaline earth metal.
14. The process of any of embodiments 1 to 13, wherein in (i), the one or more support materials contain substantially no Al₂O₃ and/or SiO₂, preferably substantially no Al₂O₃ and SiO₂, more preferably substantially no Al and/or Si, and more preferably substantially no Al and Si.
15. The process of any of embodiments 1 to 14, wherein in (i), the one or more support materials contain substantially no carbon nanotubes, preferably substantially no elemental carbon, and more preferably substantially no carbon.
16. The process of any of embodiments 1 to 15, wherein in (i), the catalyst comprises Ru in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
17. The process of any of embodiments 1 to 16, wherein in (i), from 95 to 100 wt.-% of the catalyst consists of Ru and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
18. The process of any of embodiments 1 to 17, wherein in (i), the catalyst further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalyst further comprises KOH and/or LiOH, preferably KOH.
19. The process of embodiment 18, wherein the catalyst comprises the one or more alkali metal hydroxides in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
20. The process of embodiment 18 or 19, wherein from 95 to 100 wt.-% of the catalyst consists of Ru, the one or more alkali metal hydroxides, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
21. The process of any of embodiments 1 to 20, wherein in (i), the catalyst is in the form of a molding and/or in powder form, preferably in the form of a molding, and more preferably in the form of extrudates or tablets.
22. The process of embodiment 21, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
23. The process of embodiment 21 or 22, wherein the extrudates are split, and the catalyst is in the form of extrudates of a split sieve fraction in the range of from 50 μm to 2.5 mm, preferably of from 100 μm to 1.5 mm, more preferably of from 200 μm to 1 mm, more preferably of from 250 to 700 μm, and more preferably of from 300 to 500 μm.
24. The process of embodiment 21, wherein the tablets have a four-hole cross-section, preferably a four-hole cross-section and four flutes.
25. The process of any of embodiments 1 to 24, wherein contacting is performed at a pressure in the range of from 11 to 50 bara, preferably of from 15 to 45 bara, more preferably of from 15 to 40 bara, more preferably of from 18 to 35 bara, more preferably of from 19 to 31 bara, more preferably of from 20 to 28 bara, and more preferably of from 20 to 25 bara.
26. The process of any of embodiments 1 to 25, wherein contacting is performed at a temperature in the range of from 200 to 650° C., preferably of from 250 to 600° C., more preferably of from 300 to 550° C., and more preferably of from 350 to 520° C., and more preferably of from 400 to 500° C., and more preferably of from 430 to 470° C.
27. The process of any of embodiments 1 to 26, wherein the feed gas stream prepared in (ii) comprises from 1 to 100 vol.-% of NH₃, preferably from 3 to 99.99 vol.-%, more preferably from 5 to 99.95 vol.-%, more preferably from 10 to 99.9 vol.-%, more preferably from 15 to 99.9 vol.-%, more preferably from 20 to 99.8 vol.-%, more preferably from 30 to 99.7 vol.-%, more preferably from 40 to 99.6 vol.-%, and more preferably from 50 to 99.5 vol.-%.
28. The process of any of embodiments 1 to 27, wherein the feed gas stream prepared in (ii) comprises from 0 to 50 vol.-% of N₂, preferably from 0.01 to 30 vol.-%, more preferably from 0.03 to 15 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.
29. The process of any of embodiments 1 to 28, wherein the feed gas stream prepared in (ii) comprises from 0 to 75 vol.-% of H₂, preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.
30. The process of any of embodiments 1 to 29, wherein the feed gas stream prepared in (ii) comprises from 100 to 50,000 ppmv of H₂O, preferably from 200 to 30,000 ppmv, more preferably from 500 to 25,000 ppmv, more preferably from 500 to 20,000 ppmv, more preferably from 500 to 15,000 ppmv, more preferably from 750 to 15,000 ppmv, more preferably from 1,000 to 11,000 ppmv, more preferably from 1,000 to 10,000 ppmv, more preferably from 2,000 to 8,000 ppmv, more preferably from 3,000 to 7,500 ppmv, more preferably from 4,500 to 7,000 ppmv, more preferably from 5,000 to 6,500 ppmv.
31. The process of any of embodiments 1 to 30, wherein the total amount of NH₃, N₂, and H₂ comprised in the feed gas stream prepared in (ii) is in the range from 90 to 100 wt.-%, preferably from 95 to 99.95 vol.-%, more preferably from 98 to 99.9 vol.-%, more preferably from 99 to 99.85 vol.-%, and more preferably from 99.7 to 99.8 vol.-%.
32. The process of any of embodiments 1 to 31, wherein after (i) and prior to (iii) the catalyst contained in the reactor provided in (i) is reduced in an atmosphere comprising hydrogen.
33. The process of embodiment 32, wherein the reduction is conducted at a temperature in the range of from 20 to 100° C., preferably of from 24 to 50° C., more preferably of from 26 to 35° C., and more preferably of from 28 to 32° C.
34. The process of embodiment 32 or 33, wherein the reduction is conducted in an atmosphere comprising from 1 to 50 vol.-% H₂, preferably from 2 to 20 vol.-%, more preferably from 3 to 10 vol.-%, and more preferably from 4 to 6 vol-%.
35. The process of any of embodiments 32 to 34, wherein the atmosphere comprises from 50 to 99 vol.-% of an inert gas, preferably of from 80 to 98 vol.-%, more preferably of from 90 to 97 vol.-%, and more preferably from 94 to 96 vol.-%.
36. The process of any of embodiments 1 to 35, wherein the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.
37. The process of embodiment 36, wherein the feed gas stream prepared in (ii) further comprises CO₂ and one or more hydrocarbons, and wherein the feed gas stream preferably comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O.
38. The process of embodiment 36, wherein the feed gas stream prepared in (ii) further comprises H₂O and one or more hydrocarbons, and wherein the feed gas stream preferably comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂.
39. The process of embodiment 36, wherein the feed gas stream prepared in (ii) further comprises CO₂, H₂O, and one or more hydrocarbons.
40. The process of any of embodiments 36 to 39, wherein the one or more hydrocarbons are selected from the group consisting of alkanes and mixtures thereof, preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof.
41. The process of any of embodiments 36 to 40, wherein contacting is performed at a pressure in the range of from greater than 10 to 50 bara, preferably of from 12 to 45 bara, more preferably of from 15 to 40 bara, more preferably of from 18 to 35 bara, and more preferably of from 20 to 30 bara.
42. The process of any of embodiments 36 to 41, wherein the feed gas stream prepared in (ii) comprises from 0.1 to 75 vol.-% of NH₃, preferably from 0.3 to 60 vol.-%, more preferably from 0.5 to 50 vol.-%, more preferably from 0.8 to 40 vol.-%, and more preferably from 1 to 30 vol.-%.
43. The process of any of embodiments 36 to 42, wherein the feed gas stream prepared in (ii) comprises from 10 to 70 vol.-% of the one or more hydrocarbons, preferably from 12 to 60 vol.-%, and more preferably from 15 to 50 vol.-%.
44. The process of any of embodiments 36 to 43, wherein the feed gas stream prepared in (ii) comprises from 0 to 75 vol.-% of H₂O, preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, and more preferably from 10 to 60 vol.-%.
45. The process of any of embodiments 36 to 44, wherein the feed gas stream prepared in (ii) comprises from 0 to 60 vol.-% of CO₂, preferably from 1 to 58 vol.-%, more preferably from 3 to 56 vol.-%, more preferably from 5 to 54 vol.-%, more preferably from 8 to 52 vol.-%, and more preferably from 10 to 50 vol.-%.
46. The process of any of embodiments 36 to 45, wherein the feed stream displays an H₂O:C molar ratio of H₂O to carbon contained in the one or more hydrocarbons in the range of from 0 to 4, preferably of from 0.1 to 3, more preferably of from 0.3 to 2.5, more preferably of from 0.4 to 2, and more preferably of from 0.5 to 1.6
47. The process of any of embodiments 36 to 46, wherein the feed stream displays a CO₂:C molar ratio of CO₂ to carbon contained in the one or more hydrocarbons in the range of from 0 to 4, preferably of from 0.1 to 3, more preferably of from 0.2 to 2, and more preferably of from 0.3 to 1.5.
48. The process of any of embodiments 36 to 47, wherein the feed stream displays an NH₃:C molar ratio of NH₃ to carbon contained in the one or more hydrocarbons in the range of from 0 to 5, preferably of from 0 to 4, more preferably of from 0.001 to 3, more preferably of from 0.005 to 2, and more preferably of from 0.01 to 1.
49. The process of any of embodiments 1 to 48, wherein the feed stream is fed into the reactor at a gas hourly space velocity in the range of from 500 to 20,000 h⁻¹, preferably of from 500 to 16,000 h⁻¹, more preferably of from 700 to 14,000 h⁻¹, more preferably of from 800 to 12,000 h⁻¹, more preferably of from 900 to 10,000 h⁻¹, more preferably of from 1,000 to 8,000 h⁻¹, and more preferably of from 3,000 to 5,000 h⁻¹.
50. The process of any of embodiments 36 to 49, wherein the effluent gas stream removed in (iv) further comprises CO₂.
51. The process of any of embodiments 36 to 50, wherein the effluent gas stream removed in (iv) displays a stoichiometry number R in the range of from 0.1 to 3, wherein R is defined according to formula (I):

$$R = \frac{c ( {H}_{2} ) - c ( {CO}_{2} )}{c ( {CO}_{2} ) + c ( CO )} , \qquad ( I )$$

wherein c(H₂), c(CO₂), and c(CO) stand for the molar concentration of H₂, CO₂, and CO in the effluent gas stream, respectively.
52. The process of embodiment 51, wherein the stoichiometry number R is in the range of from 1 to 2.5, preferably of from 1.3 to 2.2.
53. The process of embodiment 51, wherein R>2.
54. The process of any of embodiments 36 to 50 and 53, wherein the effluent gas stream removed in (iv) displays an H₂:CO molar ratio of >2.
55. The process of embodiment 51, wherein the stoichiometry number R is in the range of 0.5 to 3, preferably of from 1 to 2.2, and more preferably of 1.3 to 1.7.
56. The process of any of embodiments 36 to 55, wherein the effluent gas stream removed in (iv) comprises from 10 to 90 vol.-% of H₂, preferably from 20 to 80 vol.-%, more preferably from 30 to 70 vol.-%, more preferably from 40 to 65 vol.-%, and more preferably from 45 to 60 vol.-%.
57. The process of any of embodiments 36 to 56, wherein the effluent gas stream removed in (iv) comprises from 1 to 70 vol.-% of CO, preferably from 3 to 50 vol.-%, more preferably from 5 to 40 vol.-%, more preferably from 10 to 35 vol.-%, and more preferably from 15 to 30 vol.-%.
58. The process of any of embodiments 36 to 57, wherein the effluent gas stream removed in (iv) comprises from 1 to 50 vol.-% of CO₂, preferably from 3 to 45 vol.-%, more preferably from 5 to 40 vol.-%, more preferably from 8 to 35 vol.-%, more preferably from 10 to 30 vol.-%, and more preferably from 12 to 25 vol.-%.
59. The process of any of embodiments 1 to 58, wherein the effluent gas stream removed in (iv) is employed in a process for the production of methanol, for the production of dimethyl ether, or for the production of methanol and dimethylether.
60. The process of any of embodiments 1 to 59, wherein the effluent gas stream removed in (iv) is employed in a process for the production of hydrocarbons, preferably according to the Fischer-Tropsch process.
61. The process of any of embodiments 1 to 60, wherein the effluent gas stream removed in (iv) is employed in a process for the production of alcohols, preferably of alkanols, more preferably of C1 to C10 alkanols, more preferably of C2 to C8 alkanols, more preferably of C2 to C6 alkanols, more preferably of C2 to C4 alkanols, more preferably of C2 alkanols, and more preferably of ethanol.
62. The process of any of embodiments 1 to 61, wherein at an initial stage of the process, the feed gas stream prepared in (ii) and fed into the reactor in (iii) further comprises H₂ for reducing the catalyst.
63. The process of embodiment 62, wherein the feed gas stream prepared in (ii) and fed into the reactor in (iii) further comprises from 0.5 to 80 vol.-% of H₂, preferably from 1 to 70 vol.-%, more preferably from 2 to 60 vol.-%, more preferably from 5 to 50 vol.-%, more preferably from 15 to 40 vol.-%.
64. The process of embodiment 35, wherein the inert gas comprises one or more gases selected from the group consisting of noble gases, CO₂, and nitrogen gas, preferably from the group consisting of He, Ar, Ne, and N₂, CO₂, wherein more preferably the inert gas comprises CO₂, N₂, or CO₂ and N₂, wherein more preferably the inert gas comprises N₂, wherein more preferably the inert gas is N₂.

### DESCRIPTION OF THE FIGURES

FIG. 1 displays the results of NH₃ reforming at a GHSV of 2000 h⁻¹, p(NH₃)=30 bara and cofeeding of 10,000 ppm-vol of H₂O. The catalysts were tested between 350 and 650° C. The results obtained for 5 wt.-% of Ru on ZrO₂, without (Catalyst from Example 1) and with (Catalyst from Example 2) 5 wt.-% KOH promotion is shown, as well as the results obtained with the Mg—Al-spinel support loaded with 2.5 wt. % Ru and promoted with 4.5 wt. % LiOH according to Example 3.

FIG. 2 displays the results of NH₃ reforming for the catalyst according to Example 2 at GHSV of 8000 h⁻¹, p(NH₃)=10 bara and co-feeding of 5,000 ppm-vol of H₂O. The catalyst was tested between 300 and 600° C.

FIG. 3 displays the XRD pattern of the catalyst of Example 3, wherein the Mg, Al-spinel structure is clearly identified as constituting support material.

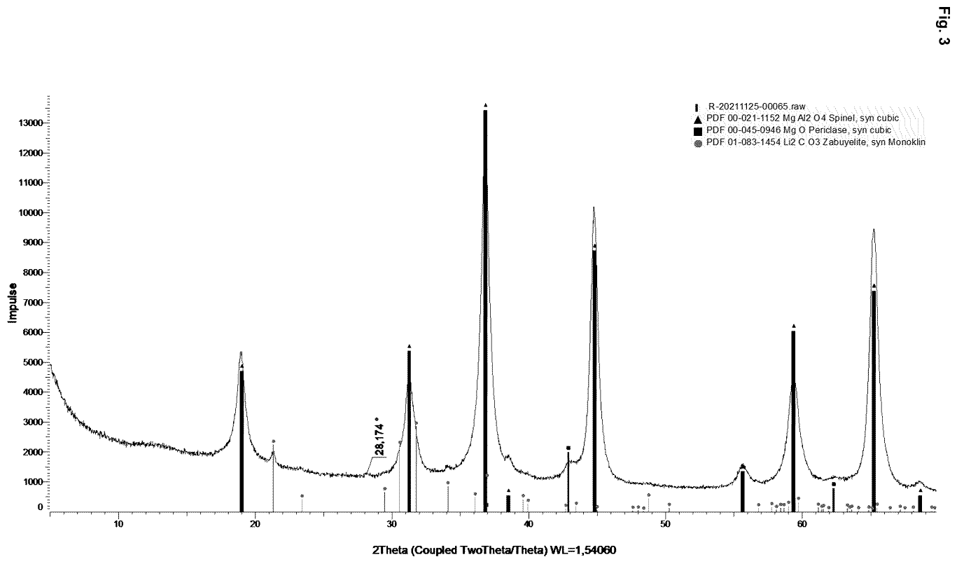

### EXPERIMENTAL SECTION

The present invention is further illustrated by the following examples.

### Example 1: Preparation of Ru (5 wt.-%) Supported on ZrO₂

Ru supported on ZrO₂ was prepared according to Example 8 of WO 2015/086639 by impregnation of a ruthenium salt solution onto a zirconium oxide powder (D9-89, BASF, BET surface area: 78 m²/g, pore volume: 0.84 ml/g), for obtaining Ru supported on ZrO₂ at a loading of 5 wt.-%. The catalyst was then extruded to form extrudates having a diameter of 3 mm.

### Example 2: Preparation of Ru (5 wt.-%) and KOH (5 wt.-%) Supported on ZrO₂

A 5 g sample of the 5 wt.-% Ru on ZrO₂ extrudates as obtained from example 1 was subject to impregnation with a KOH solution. To this effect, 5 g of the extrudates obtained from Example 1 were split to form fractions in the range of 315 to 500 microns, which was then impregnated via incipient wetness impregnation with 0.25 g of KOH dissolved in 1.65 ml of water. The sample was then dried at 120° C. and subsequently calcined under inert atmosphere at 500° C. for 2 hours.

### Example 3: Preparation of Ru (2.5 wt.-%) and LiOH (4.5 wt.-%) Supported on MgAl₂O₄ Spinel

A hydrotalcite precursor (Pural MG30 from Sasol) was calcined at 950° C. for 1 hour and used as support. 10 g of the support as split fractions of 315-500 microns were impregnated with 1.41 g of Ru(NO)(NO₃)₃ solution (19.7 wt.-% Ru in the solution), wherein prior to impregnation the solution was further mixed with 9.5 g of water and 1.38 g of Li(NO³). The solution was then impregnated on the support, dried at 120° C. for 2 h and calcined at 500° C. for 2 h under synthetic air consisting of 21 vol.-% O₂ and 79 vol.-% N₂.

### Example 4: Catalytic Tests in NH₃-Reforming Under High Pressure

Prior to testing, the catalysts were activated in a reducing atmosphere of 5% H₂ in Ar at a temperature of 30° C. (dwell time 1 h, heating rate 2° C./min). After activating the catalysts, the feed was applied (see tables below, NH₃+H₂O+5 vol.-% of Ar). In the respective tests, the pressure p(NH₃) was set to 1, 10, 30, and 50 bara. The gas hourly space velocity (GHSV) with respect to the NH₃ content was set to 2,000, 4,000, 8,000, or 16,000 h⁻¹. The temperatures were varied between 300 and 650° C.

A 650° C. dwell time of 36 h served as an aging step to monitor the stability of the catalysts. The reference conversion at 450° C. was then measured after said aging step. As may be taken from the results shown in Table 1, the deactivation was below 10% of the initial activity.

TABLE 1
Results from catalyst testing demonstrating
the stability of the Ru/ZrO₂ system.

| | Sample from | Sample from |
|---|---|---|
| | Example 2 | Example 1 |
| | (Ru + KOH/ZrO₂) | (Ru/ZrO₂) |
| Temperature | 5,000 ppmvol H₂O | 5,000 ppmvol H₂O |
| (after aging | GHSV = 8000 h⁻¹ | GHSV = 8000 h⁻¹ |
| at 650° C.) | p(NH₃) = 30 bar | p(NH₃) = 30 bar |
| 450° C. | 94% | 92% |

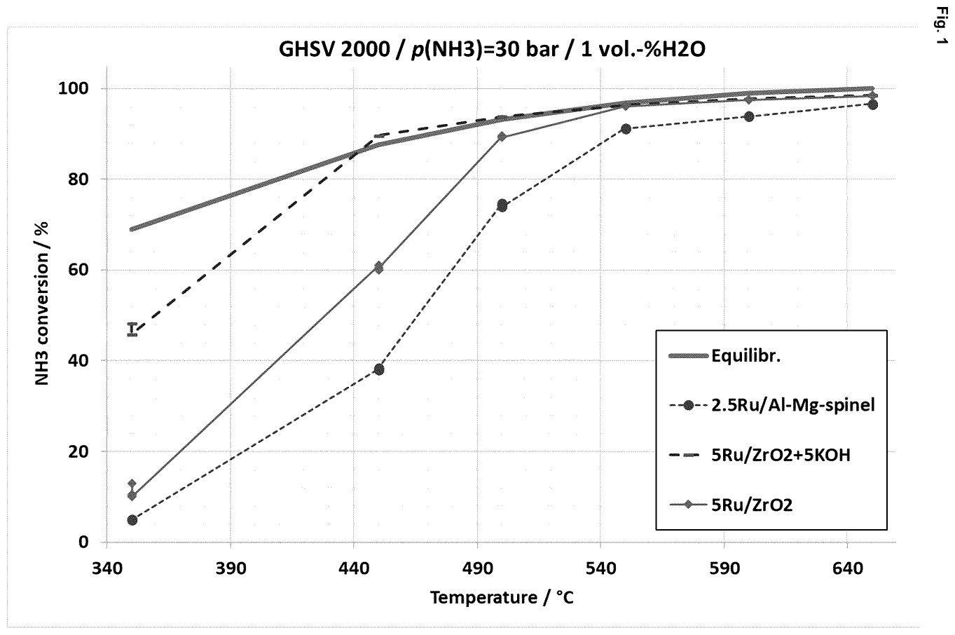

Table 2 shows the results from the experiment at a gas hourly space velocity (GHSV) of 2,000 h⁻¹ at p(NH₃)=30 bara for the catalysts from Example 1-3, respectively. The H₂O content in the feed was set 10,000 ppmvol. The temperature was increased in steps of 50° C. The NH₃-conversion is given in %. As may be taken from the results from testing displayed in FIG. 1, at 550° C. the catalysts approached equilibrium conversion, wherein the most active catalyst from Example 2 approaches equilibrium conversion already at 450° C.

TABLE 2
Results for the conversion of ammonia over the Ru-based catalysts of Examples 1 to 3.

| | | | | Example 3 | Example 2 | |
|---|---|---|---|---|---|---|
| | | | | (Ru + LiOH/ | (Ru + KOH/ | Example 1 |
| | | | | spinel) | ZrO₂) | (Ru/ZrO₂) |
| Temperature | GHSV | H₂O | p(NH₃) | x(NH₃) | x(NH₃) | x(NH₃) |
| ° C. | h⁻¹ | ppm vol | bara | [%] | [%] | [%] |
| 350 | 2,000 | 10,000 | 30 | 4.86 | 45.75 | 10.01 |
| 450 | 2,000 | 10,000 | 30 | 38.36 | 89.60 | 60.42 |
| 500 | 2,000 | 10,000 | 30 | 73.86 | 93.73 | 89.26 |
| 550 | 2,000 | 10,000 | 30 | 91.09 | 96.26 | 96.10 |
| 600 | 2,000 | 10,000 | 30 | 93.74 | 97.68 | 97.52 |
| 650 | 2,000 | 10,000 | 30 | 96.45 | 98.48 | 98.39 |

Table 3 shows the NH₃ conversion at a GHSV of 2,000 h⁻¹ at two reference temperatures at p(NH₃)=30 and 50 bara. The water content in the feed was set to 10,000 ppmv.

TABLE 3
Results for the conversion of ammonia at 30 and 50
bara p(NH3) of the catalysts of Examples 1 and 2.

| | Sample from | Sample from |
|---|---|---|
| | Example 2 | Example 1 |
| | (Ru + KOH/ZrO₂) | (Ru/ZrO₂) |
| | 10,000 ppmv H₂O | 10,000 ppmv H₂O |
| Temperature | GHSV = 2,000 h − 1 | GHSV = 2,000 h − 1 |
| ° C. | p(NH₃) = 30 bara | p(NH₃) = 50 bara |
| 450 | 89.6 | 84.3 |
| 550 | 96.3 | 94.1 |

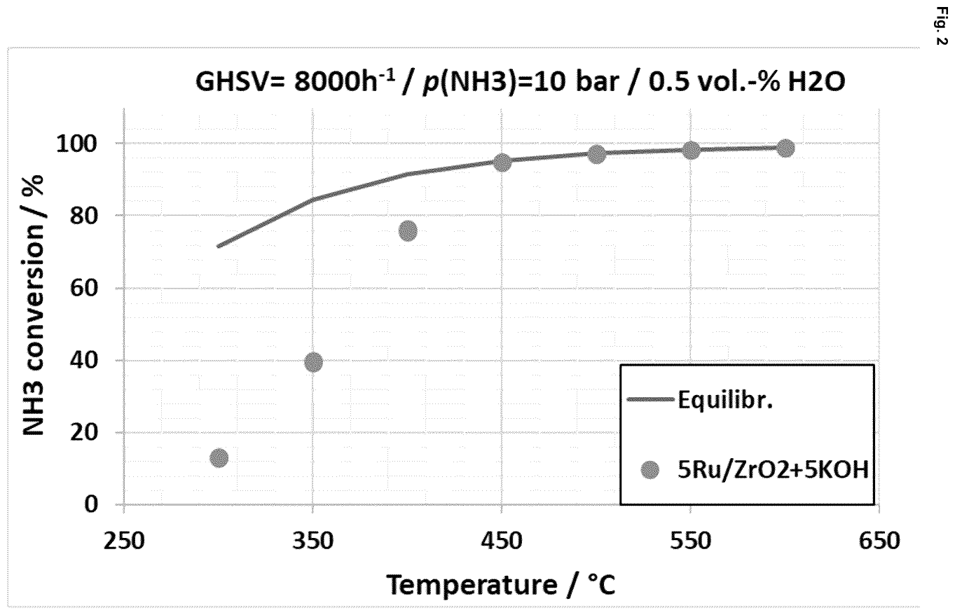

Table 4 shows the NH₃ conversion of the most active 5 wt.-% Ru on ZrO₂ promoted with 5 wt.-% of KOH. The experiments were conducted at 1, 10 and 30 bara of ammonia p(NH₃). The temperatures were varied between 300 and 600° C. at a GHSV of 8000 h⁻¹. The water content in the feed was set to 5000 ppmv. As may be taken from the results from testing displayed in FIG. 2, equilibrium conversion was reached by the catalyst according to Example 2 at 450° C., wherein almost 80% of NH₃ conversion was already reached at 400° C.

TABLE 4
Results for the catalyst of Example 2 in the conversion of ammonia at 400°
C. and 1, 10, and 30 bara of p(NH3) and at 10 bara and various temperatures.

| | Sample from Example 2 (Ru + KOH/ZrO₂) | | |
|---|---|---|---|
| | 5000 ppmv H₂O | 5000 ppmv H₂O | 5000 ppmv H₂O |
| Temperature | GHSV = 8000 h⁻¹ | GHSV = 8000 h⁻¹ | GHSV = 8000 h⁻¹ |
| ° C. | p(NH₃) = 1 bara | p(NH₃) = 10 bara | p(NH₃) = 30 bara |
| 300 | — | 13.2 | — |
| 350 | — | 39.4 | — |
| 400 | 95.5 | 75.9 | 63.2 |
| 450 | — | 94.9 | — |
| 500 | — | 97.1 | — |
| 550 | — | 98.3 | — |
| 600 | — | 98.9 | — |

Thus, as may be taken from the results obtained from the testing of the respective catalysts, a process is provided by the present invention which surprisingly affords a highly effective decomposition of ammonia at high pressures. Furthermore and quite unexpectedly, the process affords a highly effective decomposition at low temperatures despite the high pressure involved. In addition thereto, it has quite unexpectedly been found that the inventive process also affords a highly effective process despite the harsh hydrothermal conditions under high pressure due to water present during the ammonia decomposition reaction when using industrial grade ammonia which contains small amounts of water for stabilization purposes.

### Example 5: Preparation of Ru (5 wt.-%) and KOH (5 wt.-%; Corresponding to 3.5 wt.-% K) Supported on MgAl₂O₄ Spinel

A hydrotalcite precursor (Pural MG30 from Sasol) was calcined at a temperature in the range of from 850 to 980° C. and for a duration in the range of 1 to 3 h, then used as support. 93 g of the support as molding were impregnated with 27 g of Ru (NO)(NO₃)₃ solution (19.7 wt.-% Ru in the solution). After drying at 180° C. for 4 h, the Ru containing molding were impregnated with 5.105 g of K (OH). The resulting material was then dried at 120° C. for 2 h and calcined at 500° C. for 2 h under synthetic air consisting of 21 vol.-% O₂ and 79 vol.-% N₂.

### Example 6: Catalytic Tests in NH₃-Reforming Under High Pressure

Prior to testing, the catalyst according to Example 4 was activated in a reducing atmosphere of 5% H₂ in Ar at a temperature of 30° C. (dwell time 1 h, heating rate 2° C./min). After activating the catalyst, the feed was applied (see tables below, NH₃+H₂O+5 vol.-% of Ar). In the respective test, the pressure p(NH₃) was set to 30 bara. The gas hourly space velocity (GHSV) with respect to the NH₃ content was set to 4,000 h⁻¹. The temperatures were varied between 300 and 650° C.

Table 5 shows the results from the experiment. The H₂O content in the feed was set 5,000 volume-ppm (ppmvol). The temperature was increased in steps of 50° C. The NH₃-conversion is given in %. As may be taken from the results from testing displayed in Table 5, at 500° C. the catalyst approached equilibrium conversion.

TABLE 5
Results for the conversion of ammonia over
the Ru-based catalyst of Example 5.

| | | | | Example 5 |
|---|---|---|---|---|
| | | | | (Ru + KOH/ |
| Temperature | GHSV | H₂O | p(NH₃) | spinel) |
| ° C. | h⁻¹ | ppm vol | bara | x(NH₃) [%] |
| 300 | 4,000 | 5,000 | 30 | 4.56 |
| 350 | 4,000 | 5,000 | 30 | 21.80 |
| 400 | 4,000 | 5,000 | 30 | 49.98 |
| 450 | 4,000 | 5,000 | 30 | 81.19 |
| 500 | 4,000 | 5,000 | 30 | 93.30 |
| 550 | 4,000 | 5,000 | 30 | 95.91 |
| 600 | 4,000 | 5,000 | 30 | 97.37 |
| 650 | 4,000 | 5,000 | 30 | 98.26 |

As for the testing of the catalysts of Examples 1-3, it may be taken from the results obtained from the testing of the catalyst of Example 5 that a process is provided by the present invention which surprisingly affords a highly effective decomposition of ammonia at high pressures. Furthermore and quite unexpectedly, the process affords a highly effective decomposition at low temperatures despite the high pressure involved. In addition thereto, it has quite unexpectedly been found that the inventive process also affords a highly effective process despite the harsh hydrothermal conditions under high pressure due to water present during the ammonia decomposition reaction when using industrial grade ammonia which contains small amounts of water for stabilization purposes.

### CITED PRIOR ART

K. Lamb et. al. in Int. J. of Hydrogen Energy 2019, 44, 3726-3736
A. Di Carlo et al. in Int. J. of Hydrogen Energy 2014, 39, 808-814
T. A. Le et al. in Korean J. Chem. Eng. 2021, 38 (6), 1087-1103
M. Miyamoto et al. in Int. J. of Hydrogen Energy 2018, 43, 730-738
B. Lorenzut et al. in ChemCatChem 2010, 2, 1096-1106
Z. Wang et al. in Int. J. of Hydrogen Energy 2019, 44, 7300-7307
WO 2015/086639 A2
WO 2018/046393 A1
S.-F. Yin et al. in Applied Catalysis B Environmental 2004, 48, 237-241
S. Sayas et al. in Catal. Sci. Technol. 2020, 10, 5027-5035

1.-15. (canceled)

16. A process for the reforming of ammonia, wherein the process comprises
(i) providing a reactor containing a catalyst comprising Ru and one or more support materials, wherein Ru is supported on the one or more support materials, wherein the one or more support materials display a BET surface area of 20 m²/g or more, and wherein the catalyst contains 1 wt.-% or less of Ni and Co calculated as the respective element and based on 100 wt.-% of the catalyst;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of greater than 10 bara, and at a temperature in the range of from 200 to 750° C.;
(iv) removing an effluent gas stream from the reactor, the effluent gas stream comprising H₂ and N₂.

17. The process of claim 16, wherein in (i), the one or more support materials display a pore volume in the range of from 0.2 to 3 ml/g.

18. The process of claim 16, wherein in (i), the one or more support materials are selected from the group consisting of metal oxides.

19. The process of claim 16, wherein in (i), the one or more support materials contain substantially no CaO and/or MgO.

20. The process of claim 16, wherein in (i), the catalyst comprises Ru in an amount in the range of from 0.5 to 15 wt.-% based on 100 wt.-% of the total amount of the one or more support materials.

21. The process of claim 16, wherein in (i), the catalyst further comprises one or more alkali metal and/or alkaline earth metal hydroxides, wherein the one or more alkali metal and/or alkaline earth metal hydroxides are supported on the one or more support materials supporting Ru.

22. The process of claim 21, wherein the catalyst comprises the one or more alkali metal hydroxides in an amount in the range of from 0.5 to 15 wt.-% based on 100 wt.-% of the total amount of the one or more support materials.

23. The process of claim 16, wherein in (i), the catalyst is in the form of a molding and/or in powder form.

24. The process of claim 16, wherein the feed gas stream prepared in (ii) comprises from 100 to 50,000 ppmv of H₂O.

25. The process of claim 16, wherein the total amount of NH₃, N₂, and H₂ comprised in the feed gas stream prepared in (ii) is in the range from 90 to 100 wt.-%.

26. The process of claim 16, wherein the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

27. The process of claim 26, wherein the feed gas stream prepared in (ii) further comprises CO₂ and one or more hydrocarbons.

28. The process of claim 26, wherein the feed gas stream prepared in (ii) further comprises H₂O and one or more hydrocarbons.

29. The process of claim 26, wherein the feed gas stream prepared in (ii) further comprises CO₂, H₂O, and one or more hydrocarbons.

30. The process of claim 26, wherein the one or more hydrocarbons are selected from the group consisting of alkanes and mixtures thereof.
